(19) United States
(12) Patent Application Publication
(10) Pub. No.: US 2025/0167593 A1
(43) Pub. Date: May 22, 2025

(54) USER-CONFIGURABLE WIRELESS CHARGING MODULE

(71) Applicant: Molex, LLC, Lisle, IL (US)

(72) Inventors: Christian Seth, Schoenefeld (DE); Wolfgang Degner, Schoenefeld (DE); Mathias Plaschnick, Schoenefeld (DE); Lukas Brandt, Schoenefeld (DE); Frank Scholz, Schoenefeld (DE); Fabian Kerl, Hannover (DE)

(21) Appl. No.: 18/953,116

(22) Filed: Nov. 20, 2024

Related U.S. Application Data
(60) Provisional application No. 63/600,847, filed on Nov. 20, 2023.

(51) Int. Cl. H02J 50/10; H02J 50/00; H02J 50/40; H02J 50/90

(52) U.S. Cl. CPC H02J 50/10; H02J 50/005; H02J 50/402; H02J 50/90

(57) ABSTRACT

A wireless charging module can include a base, a charging coil module, and a switch. The charging coil module can be releasably securable to the base. The charging coil module can include one or more electrical connectors to electrically engage with the base when the charging coil module is secured to the base. The charging coil module can be interchangeable between a single coil module and a multi-coil module. The wireless charging module can be configured to wirelessly charge a mobile device when the charging coil module is secured to the base. The switch can be movable between a first configuration and a second configuration. The switch can be configured to secure the charging coil module to the base in the first configuration and the switch can be configured to release the charging coil module from the base in the second configuration.

### BACKGROUND

Wireless chargers are commonly used to charge mobile devices, such as cell phones, tablet computers, and smart watches. Wireless chargers often include a transmitting coil to interact with a receiving coil of a device to charge the device wirelessly. Vehicles can include wireless chargers to both wirelessly power a device and wirelessly connect the device to the vehicle, such as for transmission of data between the vehicle and the device for infotainment purposes.

### BRIEF DESCRIPTION OF THE DRAWINGS

In the drawings, which are not necessarily drawn to scale, like numerals can describe similar components in different views. Like numerals having different letter suffixes can represent different instances of similar components. The drawings illustrate generally, by way of example, but not by way of limitation, various embodiments discussed in the present document.

FIG. 1 is an isometric view of a magnetic alignment system.

FIG. 2 is a cross-sectional view of a system including a mobile device in alignment with a wireless charger device.

FIG. 3 is an exploded view of an example mobile device.

FIG. 4 shows a simplified back view of a mobile device.

FIG. 5 is an isometric view of a wireless charging module.

FIG. 6 is an isometric view of a charging coil module of a wireless charging module.

FIG. 7 is an inverted, exploded view of a charging coil module of a wireless charging module.

FIG. 8 is an isometric view of an antenna board of a charging coil module.

FIG. 9 is an isometric view of an open reed switch system.

FIG. 10 is an isometric view of an electronic switch.

FIG. 11 illustrates an isometric view of a hook system in a first configuration.

FIG. 12 is an isometric view of a base of a wireless charging module.

FIG. 13 is an exploded view of a base of a wireless charging module.

FIG. 14 is an isometric view of a slide switch in an example wireless charger system.

FIG. 15 is an isometric view of an interlocking latching system in an example wireless charger system.

FIG. 16 is a side view diagram of a double lever system in an example charging coil module.

FIG. 17 is a side view diagram of a single lever system in an example charging coil module.

FIG. 18 is a side view diagram of a flap switch system in an example charging coil module.

FIG. 19 is a side view of a release tool.

FIG. 20 is an isometric view of a magnetic disassembly tool.

FIG. 21A is an isometric view of a base in phantom according to some examples.

FIG. 21B is an isometric view of a charging coil module in phantom according to some examples.

FIG. 22 is a side view diagram of a magnetic assembly of a wireless charging module.

FIG. 23 is an isometric view of an example active cooling system of a wireless charging module.

### DETAILED DESCRIPTION

Wireless chargers are commonly used to charge mobile devices. When the transmitting and receiving coil are well aligned, the performance of the wireless charging system is close to the efficiency of a wired connection but avoids the hassle of needing to plug in a device and allows for a mobile device to be both wirelessly powered and wirelessly connected to the vehicle. One issue that exists is that each mobile device has its own shape (such shape being impossible to predict in advance as such shapes can change each year) and the location of a receiving coil is not uniform. Thus, it is difficult to arrange the coil of the wireless charger in a location that ensures high efficiency. In a vehicle application for a wireless charging module, as discussed in further detail below, the current designs may not be suitable in all cases. Accordingly, certain individuals would appreciate further improvements in automotive wireless charging systems.

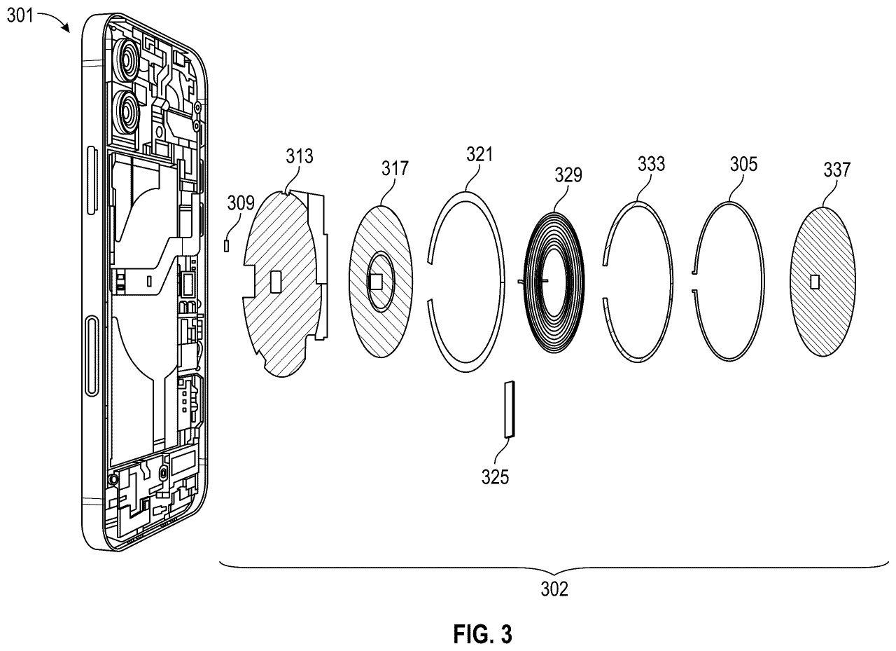

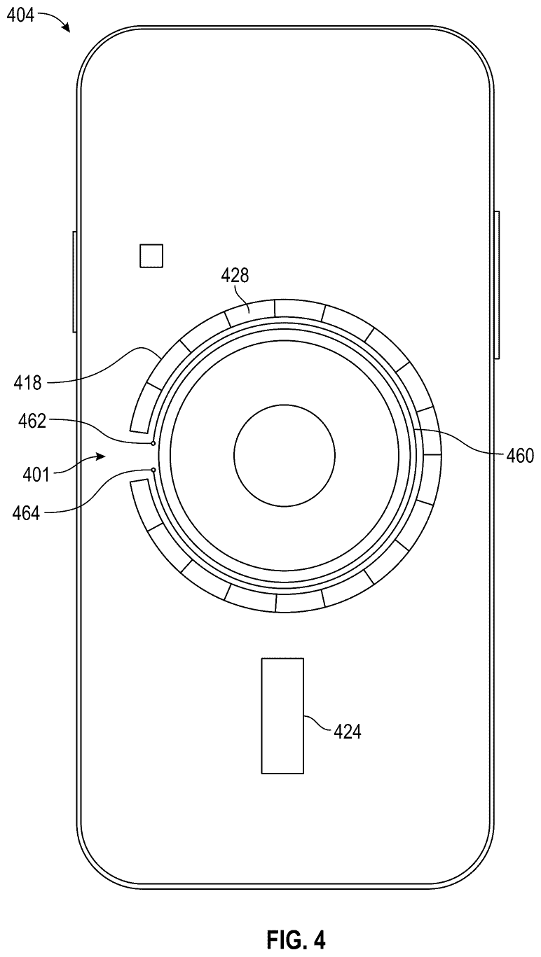

The Wireless Power Consortium (WPC) introduced the Qi2 or Qi 2.0 wireless charging standard that supports the Magnetic Power Profile (MPP), such as an IPHONE™ smartphone with MAGSAFE™ technology or other mobile device shown below in FIG. 3 and FIG. 4, etc. As discussed below, a magnetic ring is integrated around the transmitter and receiver coil in such conventional systems. But as recognized herein, the magnetic ring can have an impact on compatibility with Qi wireless charging receivers and the transmitter coil design itself. The active charging area of an MPP design is considerably smaller than that of a multi-coil array of Qi 1.x systems. For this reason, compatibility with classic Baseline Power profile (BPP) and Extended Power Profile (EPP) receivers can be limited.

The present disclosure helps to address this drawback and improve compatibility with wireless charging receivers that do not support MPP. For example, a charging system that includes charging coil modules for wireless charging modules can be used where the system thereby allows the end user to selectively use a coil module (e.g., changeout or replace an existing coil module, etc.) that offers a better experience for the respective MPP (with magnetic alignment) and EPP or BPP (without magnetic alignment) charging standard.

In some examples, the charging coil modules can include single coil and multi-coil modules that are selectively usable (e.g., interchangeable, readily detachable from, or re-attachable to (with or without tools), etc.) with a base of a wireless charging module. The charging coil modules can be removable to selectively change which charging coil module can be attached to the base of a wireless charging module. The charging coil modules can also be installable to the base of the wireless charging module. The single coil module can include a first inductive charging coil and the multi-coil module can include a plurality of inductive charging coils including at least a first coil and a second coil. An example of the first coil can be an MPP coil. An example of the second coil can be a non-MPP coil. The single coil module and the multi-coil module can be selectively interchangeable with each other such that the end user can selectively use either the single coil module or the multi-coil module to thereby customize or tailor the wireless charging module for the respective MPP (with magnetic alignment) and non-MPP (EPP/BPP without magnetic alignment) charging standards.

The multi-coil module can include two or more inductive charging coils. The two or more inductive charging coils can include at least one MPP transmitter coil and at least one classic/non-MPP transmitter coil. The at least one MPP transmitter coil can be configured according to and in compliance with the Qi2 wireless charging standard (e.g., Section 1.2 of the Wireless Power Consortium Qi Specification MPP System Specification Version 2.0 April 2023, etc.) such that a wireless charging module that includes the MPP transmitter coil will be operable at a z-gap of up to 3.2 millimeters (mm) from the coil surface to the top surface of the charger (interface surface) of the defined coil module at an operating frequency of 360 kHz. As will be discussed below, however, such a configuration is merely one possible configuration within the scope of this disclosure.

By including at least one MPP transmitter coil and at least one classic non-MPP transmitter coil, the multi-coil module can support both MPP and non-MPP wireless charging receivers and therefore offers combined advantages from both MPP transmitter coil designs and non-MPP transmitter coil designs. Accordingly, the end user can selectively changeout or replace an existing single coil module with a multi-coil module as disclosed herein to thereby combine magnetic and non-magnetic wireless charging in a relatively large charging area, e.g., for any given specification or system including Qi, etc., helping to reduce overall system cost and complexity for changing between a single coil module and a multi-coil module. Additionally, the end-user can changeout or replace an existing single coil module with a different single coil module. For example, the user can change an MPP transmitter coil module for a non-MPP transmitter coil module or vice versa.

An issue with only using a single coil is the size of the relatively small charging area as compared to the much larger top surface of the wireless charger (e.g., 180 mm×90 mm, etc.). A non-MPP receiver device (without magnets) may not be aligned at the center or around the center, such that the non-MPP receiver can stop charging at the edges of the charging area if only a single MPP coil is used. In some examples disclosed herein, the multi-coil module can include the first coil and at least one second coil, where the first coil can be an MPP coil and the second coil can be a non-MPP coil. The multi-coil module can address this issue of wireless charging non-MPP receiver devices on relatively large surfaces by combining both magnetic (defined as MPP in Qi) and non-magnetic (defined as EPP in Qi) wireless charging.

In the above-referenced Qi specification, the system can operate at about 15 watts with a z-gap of up to 3.2 millimeters while operating at about 360 kHz. Other frequencies, powers levels and z-gaps are contemplated; however, and the referenced Qi specification is not intended to be limiting. These parameters can be modified in a conventional manner to modify the capability of the system or to meet other specifications. For example, these parameters can be increased by using larger conductors, better materials, more efficient or effective components, better cooling, better shielding, or some combination thereof. For example, the transmitted power can be increased to 20 watts, 25 watts, 30 watts, or the like. Naturally, system costs will limit the ability of the system to improve as a reasonable individual will eventually decide the additional increase in performance is not worth the additional cost.

The above discussion is intended to provide an overview of subject matter of the present patent application. It is not intended to provide an exclusive or exhaustive explanation of the invention. The description below is included to provide further information about the present patent application.

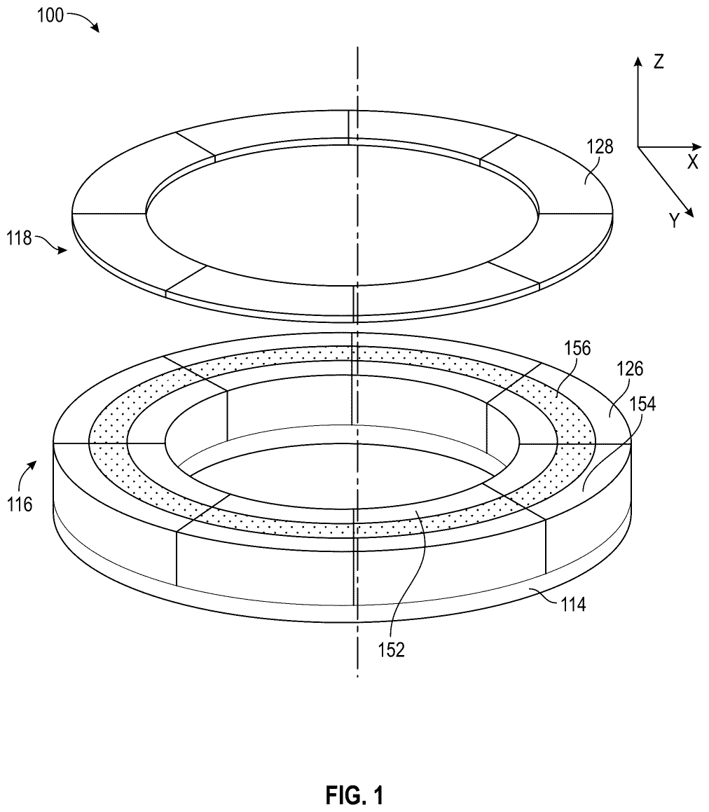

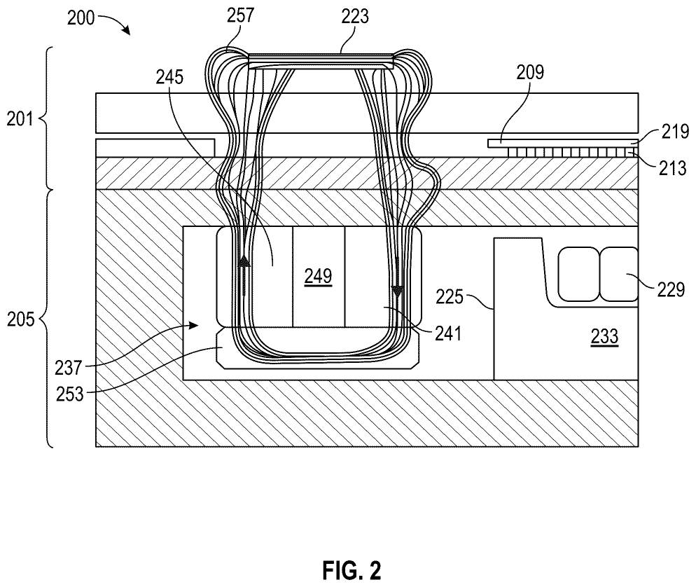

One attempt to overcome the issues discussed above has been to include adding additional coils so that one coil is always in a reasonably efficient location. Optimum efficiency, however, is not ensured with such an approach, instead such an approach can only ensure reasonable efficiency. APPLE™ has developed a wireless charging system known as MAGSAFE™ and such a system works by using two magnetic rings, one in the charger and one in the mobile device, to ensure there is a nearly ideal alignment between the transmission coil and the receiving coil (at least within the X and Y direction) and thus helps address the problem in a significant manner. FIG. 1 and FIG. 2 illustrate how the magnetic alignment system 100 functions. In operation, two coils are positioned inside each of the magnetic rings and the magnetic attraction helps ensure the coils are aligned accurately with respect to each other with only the Z-axis alignment being uncertain (because mobile devices, for example, can have a case of varying thickness).

As shown in FIG. 1, the magnetic alignment system 100 can include primary alignment component 116 and secondary alignment component 118, which can respectively include primary magnet 126 and secondary magnets 128. Each primary magnet 126 can include two arcuate pieces of magnetic material providing inner arcuate magnetic region 152 having a magnetic orientation in a first axial direction, an outer arcuate magnetic region 154 having a magnetic orientation in a second axial direction opposite the first direction, and a central non-magnetized region 156 that does not have a magnetic orientation. An annular shield 114 (also referred to as a DC magnetic shield or DC shield) can be disposed on a distal surface of primary magnets 126.

FIG. 2 is a cross-sectional view of a system 200 including a mobile device 201 in alignment with a wireless charger device 205. The coil assembly 209 of the mobile device 201 can include a receiver coil 213 and shielding 219. A secondary magnet 223 of the mobile device 201 can form a portion of secondary magnetic alignment and can have a magnetic field oriented in a radially inward direction (as shown by the arrow).

The wireless charger device 205 can include a transmitter coil assembly 225 including a transmitter coil 229 and electromagnetic shielding 233. Primary magnet 237 can form a portion of a primary magnetic alignment component and can include an inner arcuate region 241 having a magnetic field oriented in a first axial direction, an outer arcuate region 245 having a magnetic field oriented in a second axial direction opposite the first axial direction, and a non-magnetized central arcuate region 249. A DC shield 253 can be disposed on the distal surface of primary magnet 237.

When aligned, primary magnet 237 and secondary magnet 223 can produce a closed-loop magnetic flux 257. Closed-loop magnetic flux 257 can attract primary annular alignment component and secondary annular alignment component into alignment such that the respective centers of primary annular alignment component and secondary annular alignment component are aligned along a common axis. Since transmitter coil 229 is fixed in a position concentric with primary alignment component and receiver coil 213 is fixed in position concentric with secondary alignment component, transmitter coil 229 and receiver coil 213 are also aligned along a common axis, thereby enabling efficient wireless power transfer.

FIG. 3 shows an example mobile device 301 (e.g., an IPHONE™ smartphone with MAGSAFE™ technology, etc.) including wireless charging components 302. The wireless charging components can be components within the example mobile device 301 that provide wireless charging capabilities. The wireless charging components 302 can include an NFC antenna coil 305 that can be coupled with an NFC reader circuit of the mobile device 301. The wireless charging components 302 can further include a magnetometer 309, a copper-graphite electromagnetic interference (EMI) shield 313, a nanocrystalline magnetic shield 317, a magnet array 321, an alignment magnet 325, a charging coil 329, a polycarbonate housing 333, and an electric shield 337.

The electric shield 337 can be configured to block AC electric fields emitted by wireless transmitter (Tx) coil during operation while permitting AC magnetic fields to pass through. The nanocrystalline magnetic shield 317 can be configured to prevent the magnetic field from entering the mobile device 301 behind the charging Rx coil. The NFC antenna coil 305 can be configured to be disposed in the annular space between the outer edge of electric shield 337 and the inner edge of the magnet array 321. The NFC antenna coil 305 can be a single-turn multi-stranded wire coil. The magnet array 321 and the alignment magnet 325 can be configured to magnetically couple with a complementary annular magnetic alignment component and alignment magnet of a wireless charging module for aligning the mobile device's charging Rx coil with the transmit (Tx) coil of the wireless charging module in a preferred charging location and rotational orientation at which the mobile device 301 will receive maximum or optimum power from the wireless charging module.

FIG. 4 shows an example mobile device 404 (e.g., an IPHONE™ smartphone with MAGSAFE™ technology, etc.) including an NFC coil 460, annular magnetic alignment component 418 and rotational magnetic alignment component 424 that can facilitate alignment of the mobile device 404 with a wireless charging module or accessory having complementary magnetic alignment components. The mobile device 404 can include AC magnetic or electric shield(s) disposed around some or all surfaces of a wireless receiver coil. Each arcuate magnet 428 can have a magnetic orientation having a radial component, e.g., radially inward or radially outward. The annular magnetic alignment component 418 can include a gap 401 for electrical connections to a wireless receiver coil.

The rotational magnetic alignment component 424 can facilitate aligning the mobile device 404 with a wireless charging module or accessory having a complementary rotational magnetic alignment component in a preferred rotational orientation.

The NFC coil 460 can be between the annular magnetic alignment component 418 and a wireless receiver coil. The NFC coil 460 can be a single turn of a double-stranded copper wire having terminals 462, 464 for connection with an NFC reader circuit on a main logic board of the mobile device 404.

By way of further background, 15 Watt (15 W) automotive wireless chargers are commonly used for charging mobile devices (e.g., mobile phones, etc.) in vehicles for faster charging and shorter charging times of mobile devices. Although automotive wireless chargers are convenient for a user to charge a mobile device, the user can still need to manually change profiles on the mobile device to perform certain operations inside the vehicle. Advantageously, some mobile device applications can be programmed to launch at the detection of an NFC module within a vehicle. For example, a mobile device including an NFC antenna can be configured such that after detecting an NFC module within a vehicle, the mobile device can then automatically turn on or off a short-range wireless communication interface (e.g. BLUETOOTH™, etc.) of the mobile device, turn on or off a Wi-Fi interface of the mobile device, enable a Wi-Fi access point mode of the mobile device, turn cellular (e.g., LTE, etc.) data of the mobile device on or off, change a ringing volume of the mobile device, open an application (e.g., music, maps, etc.) on the mobile device, etc.

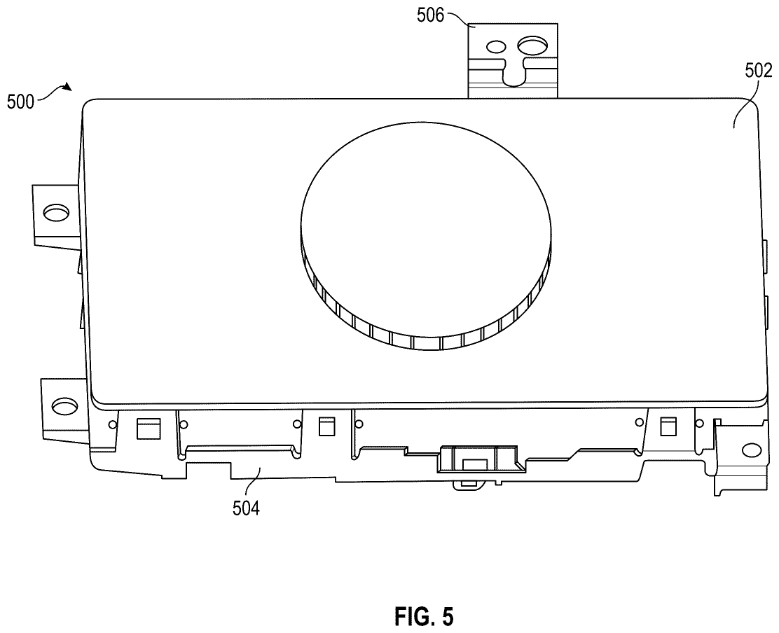

FIG. 5 is an isometric view of a wireless charger system 500. The wireless charger system 500 can include a charging coil module 502 and a base 504. The base 504 can include a clip 506.

The charging coil module 502 can be a wireless charging interface for delivering a charge to a mobile device or for sending or receiving data to or from the mobile device, such as via BLUETOOTH™, Wi-Fi, 3G, 4G LTE/LTE-A, or 5G networks, or near field communication (NFC). The charging coil module 502 can be removably coupled to, connected to, or releasably engaged with the base, such as by a user with or without tools. In some examples, the charging coil module 502 can include a single coil module including a single MPP inductive charging coil. In some examples, the charging coil module 502 can include a multi-coil module including a plurality of inductive charging coils, such as MPP coils, non-MPP coils, or a combination thereof.

The base 504 can be a rigid or semi-rigid body made of materials such as one or more of metals, plastics, foams, elastomers, ceramics, or composites. The base 504 can be configured to receive the charging coil module 502 at least partially therein to secure the charging coil module 502 to, for example, a vehicle dashboard or console.

The base 504 can include the clip 506 to couple the charging coil module 502 to the base 504. The clip 506 can be a protrusion from the base 504 that can overlap with the charging coil module 502 to hold the charging coil module 502 in place. The clip 506 can be a fastener, such as a hook, a tab, a switch, a snap-fit engagement, an adhesive, a magnet, a screw, a bolt, a threaded fastener, or any combination thereof. The clip 506 can be a rigid or semi-rigid surface made of materials such as one or more of metals, plastics, foams, elastomers, ceramics, composites, or any combination thereof. The clip 506 material may be the same as the base 504 material, or the clip 506 material may be different.

The charging coil module 502 can be a single coil module that can be interchangeable with a multi-coil module, such that either coil module can be removably coupled or releasably engaged (e.g., readily detachable from or re-attachable to, by a user with or without tools, etc.) with the base 504 of a wireless charger system 500. A user can selectively install or assemble either a single coil module or a multi-coil module with the base 504 to thereby customize or tailor the wireless charging module for the respective MPP (with magnetic alignment) and non-MPP (EPP or BPP without magnetic alignment) charging standards.

In operation of some examples, an end user can install, change, or replace a single MPP coil module of the wireless charger system 500 with a charging coil module to improve compatibility of the wireless charger system 500 with non-MPP (EPP or BPP) wireless charging receivers such that the wireless charger system 500 supports both MPP and non-MPP wireless charging receivers (e.g., smartphones, other mobile devices, etc.). Or, in another example, an end user can install, change out, or replace a multi-coil module of the wireless charger system 500 with a single MPP coil module, e.g., when the end user only has an MPP wireless charging receiver(s).

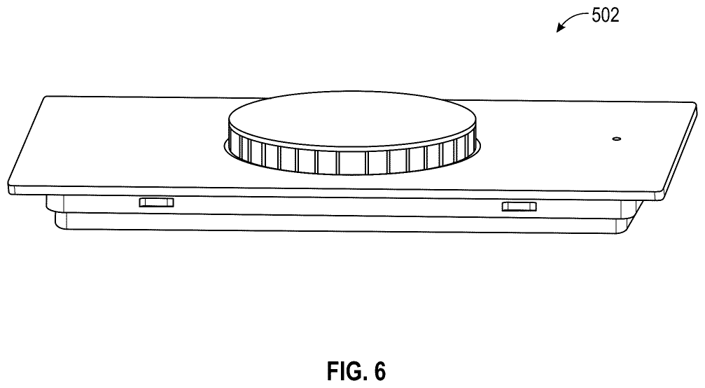

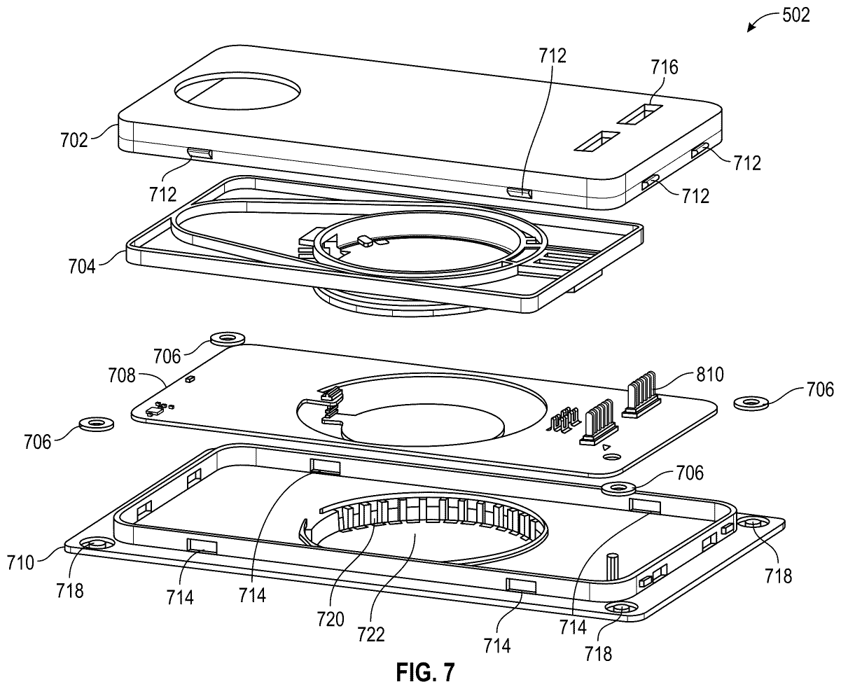

FIG. 6 is an isometric view of a charging coil module 502 of a wireless charging module. FIG. 7 is an inverted, exploded view of charging coil module 502 according to some examples. FIG. 7 has been inverted from FIG. 6 to highlight components otherwise hidden. FIGS. 6-7 are discussed together below.

The charging coil module 502 can include a module bottom cover 702, a coil assembly 704, a coil magnet 706, an antenna board assembly 708, and a module top cover 710. The antenna board assembly 708 can include a coil connector 810. The module bottom cover 702 can include a bottom cover ridge 712 and connector opening 716. The module top cover 710 can include a top cover opening 714, recesses 718, an inlet 720, and a protrusion 722.

The module bottom cover 702 can couple directly to the module top cover 710, such as through a snap-fit engagement between the bottom cover ridge 712 and the top cover opening 714, to form an interference fit. Optionally, the module bottom cover 702 and the module top cover 710 can be secured using fasteners, adhesive, or any combination thereof. When coupled, module bottom cover 702 and module top cover 710 can contain or at least partially enclose other components of the charging coil module 502, such as the coil assembly 704, the coil magnet 706, the antenna board assembly 708, or any combination thereof. The module bottom cover 702 can include a connector opening 716 configured to receive a coil connector 810 during assembly.

The coil assembly 704 can be at least partially enclosed between the module bottom cover 702 and the module top cover 710. Coil assembly 704 can include a first coil, a second coil, or any combination of multiple coils including the first coil and the second coil where the first coil can be an MPP inductive charging coil, and the second coil can be a non-MPP coil. By including both MPP inductive charging coils and non-MPP coils, the charging coil module 502 can be compatible with both MPP wireless charging receivers and non-MPP wireless charging receivers (e.g., EPP, BPP, etc.).

In some examples, the coil assembly 704 can include a single MPP inductive charging coil designed to be Qi2 compliant. The coil assembly 704 can operate at a z-gap of up to 6, 5, 4, or approximately 3.2 millimeters from the coil surface to the charging interface surface. The coil module can maintain operation of 50-600, 100-500, 200-450, 300-400, or approximately 360 kilohertz. In some examples, the coil assembly 704 can operate as a multi-coil module by including multiple wireless charging capabilities, such as by including multiple magnetic (e.g., MPP) inductive charging coils, multiple non-magnetic (e.g., EPP, BPP, etc.), or any combination thereof. The coils can be concentric with respect to each other but can also be eccentric or adjacent in some examples. By operating as a multi-coil module, a charging surface area of a wireless charger can be increased, allowing non-MPP receiving devices to be charged even if they are not perfectly aligned at the center of the charging surface.

The coil assembly 704 can also define air guidance features for guiding an air flow internally within the charging coil module 502 generally around or adjacent a charging coil, as discussed in further detail below, such as to improve airflow through the charging coil module 502 for cooling of the components of charging coil module 502 during charging operation(s).

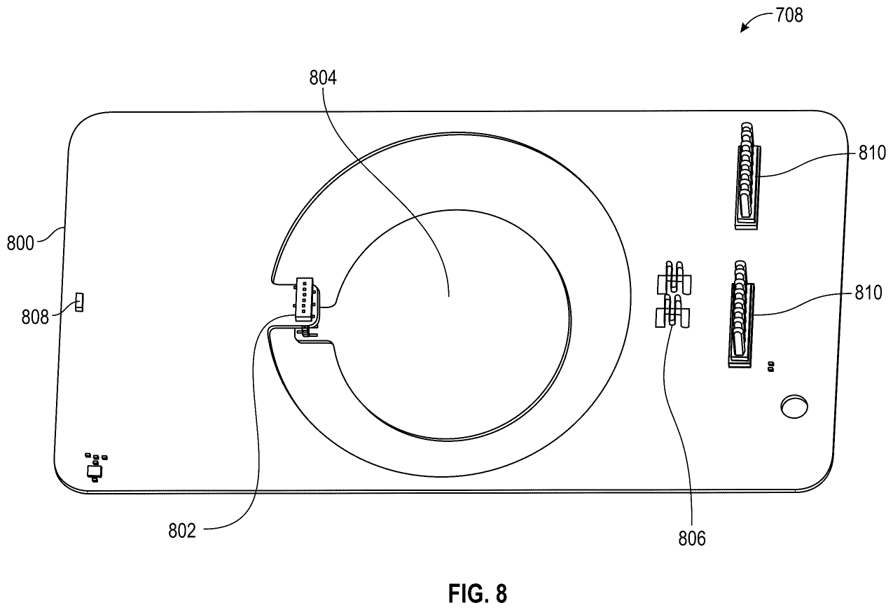

The antenna board assembly 708 can be at least partially enclosed between the module bottom cover 702 and the module top cover 710. The antenna board assembly 708 can be a printed circuit board (PCB) of a printed circuit board assembly (PCBA), or any type of PCB, circuit board, etc. The antenna board assembly 708 can include electrical components that can be connected (e.g., soldered), such as those discussed in FIG. 8. The antenna board assembly 708 can be configured for wireless communication such as BLUETOOTH™, Wi-Fi, 3G, 4G LTE/LTE-A, or 5G networks, or near field communication (NFC). The antenna board assembly 708 can be electrically coupled to the coil assembly 704, such as for power or data transfer. The antenna board assembly 708 can also help manage power transfer or communications of the wireless charger system 500.

The module top cover 710 can be connected to or secured to the module bottom cover 702. For example, the module top cover 710 can interface with the module bottom cover 702 to create a sealed or partially-sealed assembly that can help protect the internal components while maintaining airflow channels around the charging coils. The module top cover 710 can also include ventilation features, such as an inlet 720. The inlet 720 can align with the air guidance features of the coil assembly 704 to at least partially define air guidance paths, which can assist with thermal management.

The module top cover 710 can also include recesses 718. The recesses 718 can be located at or near corner portions of the top cover. The recesses 718 can be configured to receive (e.g., via friction or interference fit, etc.) a coil magnet 706 or a ferromagnetic metal member such as when the charging coil module 502 includes magnets. The coil magnet 706 can be a charging coil magnet.

The module top cover 710 can also include a protrusion 722. The protrusion 722 can be a projection extending from an upper surface of the module top cover 710. The protrusion 722 can be configured to interface with a touchpoint board 802 as discussed in relation to FIG. 8. The protrusion 722 can provide a surface for aligning a user device with the charging coil module 502 for wireless charging.

FIG. 8 is an isometric view of an antenna board assembly 708. The antenna board assembly 708 can include an antenna board 800, a touchpoint board 802, a board connector 804, a wire connector 806, a reed switch 808, and a coil connector 810.

The antenna board 800 can be a PCB (or other circuit board) that can be configured to act as a medium to connect electrical components in one or more circuits, such as through conductive pathways etched onto layers of a non-conductive substrate. The antenna board 800 can provide a base or support for circuitry within antenna board assembly 708, which can allow complex circuits to operate within a confined space. Electrical connections between components can be implemented through various connector types, such as screw terminals mechanical and electrical connections, blade and spade connectors for power transmission paths, and twist-on wire connectors for establishing electrical continuity.

The touchpoint board 802 can be a PCB (or other circuit board) that can be configured to interact with a wireless charger system (such as the wireless charger system 500 of FIG. 5) with detection capabilities, communication capabilities, or a combination thereof. The touchpoint board 802 can be an NFC board or can be or can include various other communication technologies, such as those discussed above. The touchpoint board 802 can interface with the antenna board 800 through the board connector 804, which can facilitate power transfer, communication, or a combination thereof. In some examples, the board connector 804 can be an NFC touchpoint board to antenna board connector.

The touchpoint board 802 can enable automatic responses when a mobile device is detected within a defined range of the wireless charger system 500. Automatic responses can include automatically disabling or enabling wireless communication interfaces, adjusting Wi-Fi settings, enabling Wi-Fi access point mode, modifying cellular data settings, changing device ringing volume, launching specific applications on a cellular device, or any combination thereof. The touchpoint board 802 can also incorporate electromagnetic compatibility (EMC) shielding capabilities, temperature sensing capabilities, or a combination thereof, to monitor operation conditions during wireless charging of a device.

The wire connector 806 can be an electrical component connected to (e.g., soldered) to the antenna board 800. The wire connector 806 can be a wire-to-board connector and can establish electrical connection(s) within the coil assembly 704 of FIG. 7. The wire connector 806 can interface with either a single MPP inductive charging coil, or a multiple coil assembly. The wire connector 806 can be electrically connected through common electrical connections, such as multiple pin and socket connectors, screw terminals, blade and spade connectors, or twist-on wire connectors.

The reed switch 808 can be an electrical component connected to (e.g., soldered) to the antenna board 800. The reed switch 808 can be configured to interrupt an electrical circuit if a distance between the reed switch 808 and a corresponding magnet, such as a reed magnet 904 discussed below, exceeds a predefined threshold. By interrupting the electrical circuit, the reed switch 808 can provide circuit protection during the disassembly of the wireless charger system 500 of FIG. 5, such as when removing the charging coil module 502 from the base 504. The reed switch 808 can be connected using standard through-hole or surface-mount technology techniques.

The antenna board assembly 708 can also include a coil connector 810. The coil connector 810 can be an electrical connector (e.g., a board-to-board connector) connected to (e.g., soldered) to the antenna board assembly 708. The coil connector 810 can facilitate a connection between a base board, such as a base PCBA 1306 of FIG. 12, and a charging coil module board, such as the antenna board 800 of FIG. 7. The coil connector 810 can have various connector styles, such as multi-pin header and socket arrangements, card edge connectors, board-mount power connectors, or high-speed data connectors to support a communication interface.

Board-to-board connections can utilize multiple pin and socket configurations, which can provide secure electrical connectivity between the wire connector 806 and antenna board assembly 708. The wireless charging system can incorporate industry-standard connection types, such as board-to-board connectors between a base PCBA and the antenna board assembly 708, wire-to-board connectors for coil assembly connections, through-hole mounted components, etc.

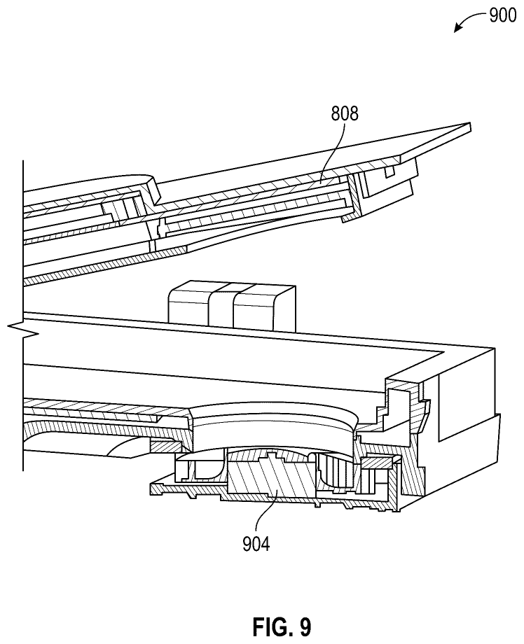

FIG. 9 is an isometric view of an open reed switch system 900. The reed switch system can include the reed switch 808 and a reed magnet 904. The reed switch 808 can be an electromechanical switch operated by an applied magnetic field. The reed switch 808 can be connected to (e.g., soldered) to a circuit board (e.g., a PCB) of a charging coil module, such as the antenna board 800. The reed switch 808 can be opened and closed with a reed magnet 904, which can be connected to or located at least partially within a base, such as base 504. When open, such as shown in FIG. 9, the reed switch 808 can interrupt an electrical circuit of the charging coil module. When closed, the reed switch 808 can close or complete the electrical circuit of the charging coil module. The open reed switch system 900 can be used to interrupt the electrical circuit of a charging coil module, such as the charging coil module 502, before the charging coil module is disassembled from a base, such as the base 504, as discussed in relation to FIG. 8. The circuit or circuits interrupted by the reed switch 808 can be a charging circuit or other circuit related to power or data transmission, such as to limit transmission of power or data when the charging coil module 502 is disconnected from the base 504.

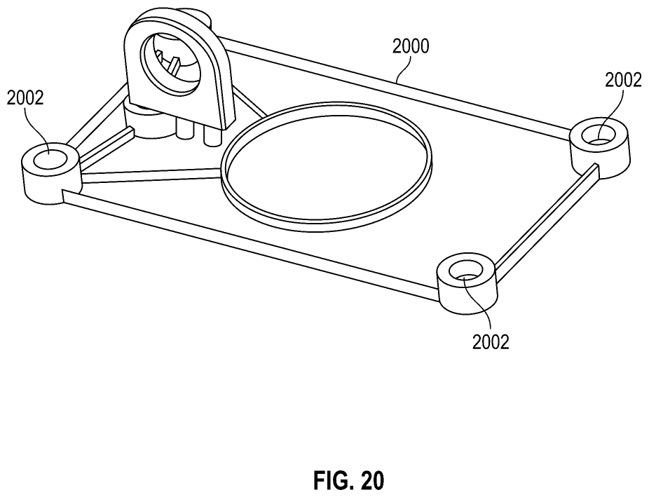

In some examples, if disassembling a charging coil module with a tool including magnets (e.g., tool 2000 of FIG. 20, etc.), then the magnet included within the tool can also operate the reed switch 808 to interrupt the electrical connection or one or more electrical circuits of the charging coil module 502 or the base 504.

If disassembling of the charging coil module from the base will be performed without the need for a tool, the electrical circuit can be interrupted when a distance between the reed switch 808 and the reed magnet 904 exceeds a defined distance as shown in FIG. 9. This can take advantage of the location of a board-to-board connector, such as coil connector 810, which can be on an opposite side of the antenna board 800 than the reed switch 808. In some examples, there can be contact overlap on the board-to-board connector while the reed switch 808 is already interrupting the electrical circuit of the charging coil module. Though a reed switch is discussed, other types of switches can be used. For example, a mechanical switch, such as a microswitch can be used. In other examples, a photosensor (e.g., a single emitter and a single detector, or combined) can be used.

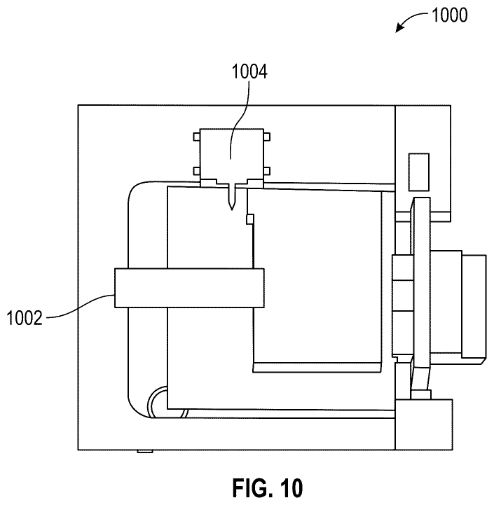

FIG. 10 is an isometric view of a switch assembly 1000, which can be the reed switch 808. The switch assembly 1000 can include a biasing element 1002 and an electronic switch 1004.

The switch assembly 1000 can be located on a charging coil module, such as the charging coil module 502 in FIG. 5. The switch assembly 1000 can be used to interrupt an electrical circuit of the charging coil module before the charging coil module is disassembled from a base, such as the base 504 in FIG. 5. In operation, the biasing element 1002 can bias the electronic switch 1004 to an off position or an on position, where a plunger or other component can overcome the biasing element 1002 to move the electronic switch 1004 to the opposite condition. The switch assembly 1000 can be configured to interrupt the electronic circuit of the charging coil module when the unlocking mechanism is activated to unlock, release, unlatch, or decouple the charging coil module from the base. In other examples, the biasing element 1002 can be any biasing element, such as a coil spring, rubber, or any combination thereof.

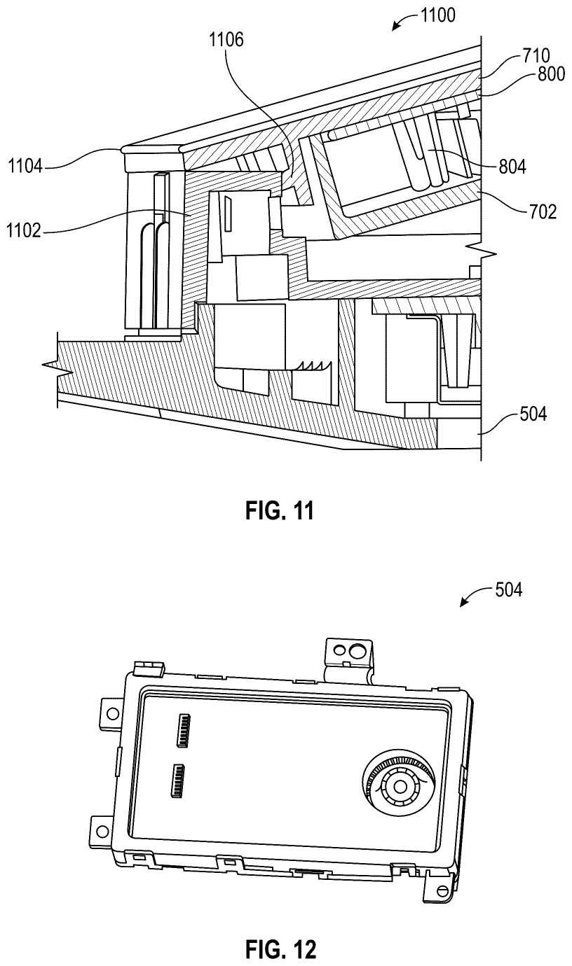

FIG. 11 illustrates an isometric view of a hook system 1100 in a first configuration. The hook system 1100 can include a hook 1102, a first side 1104 of charging coil module 502, and a board connector 804.

The hook 1102 can be a protrusion, extension, projection, or catch mechanism extending from a base top cover 1310 (discussed below). The hook 1102 can be connectable to the first side 1104 of a charging coil module. The hook 1102 can be engageable with a projection 1106 of the charging coil module 502 to limit the first side 1104 from being accidentally unlocked while the opposite second side of the replacement coil module that includes a reed switch, such as the reed switch 808 of FIG. 9., is lifted away from the base 504. The hook 1102 can be located at, near, or on the first side 1104 and can be located near or adjacent to the board connector 804 of a replacement coil module. The hook system 1100 can help limit an accidental electrical disconnection on the first side 1104. The hook system 1100 can also help limit or prevent the charging coil module from being accidentally unlocked along the first side 1104, such as by a user, vibration, mechanical shock, or any combination thereof.

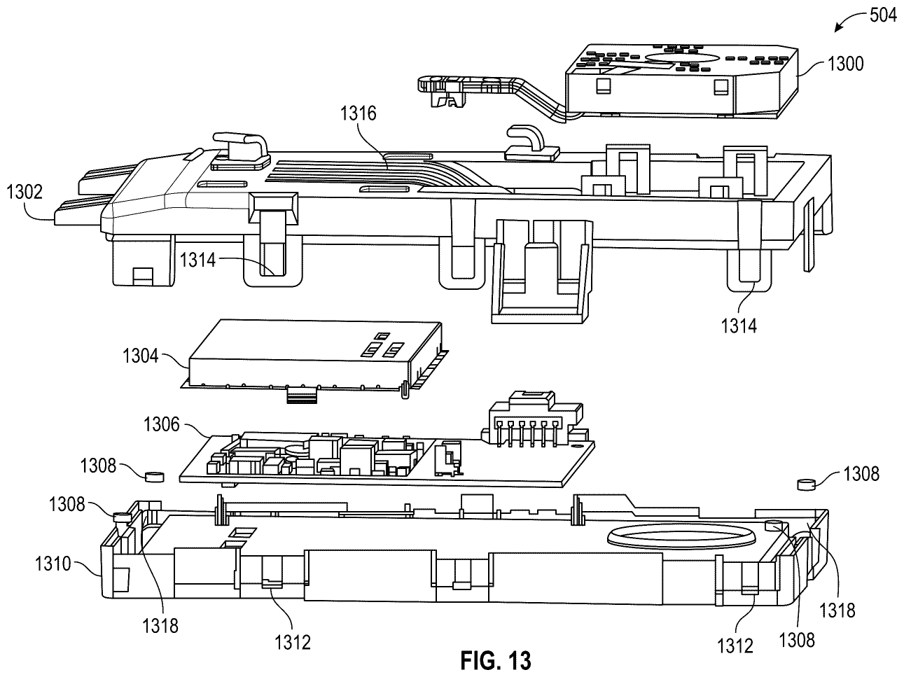

FIG. 12 is an isometric view of the base 504 of a wireless charging module. FIG. 13 is an exploded view of the base 504 of a wireless charging module. FIGS. 12-13 are discussed together below.

The base 504 can include a fan 1300, a base bottom cover 1302, an EMC shield 1304, a base PCBA 1306, base magnets 1308, and a base top cover 1310. The base top cover 1310 can include one or more base ridges 1312, which can each be a projection or protrusion. The base bottom cover 1302 can include a base opening 1314, which can be a window, opening, recess, etc., each configured to releasably receive one of the one or more base ridges 1312.

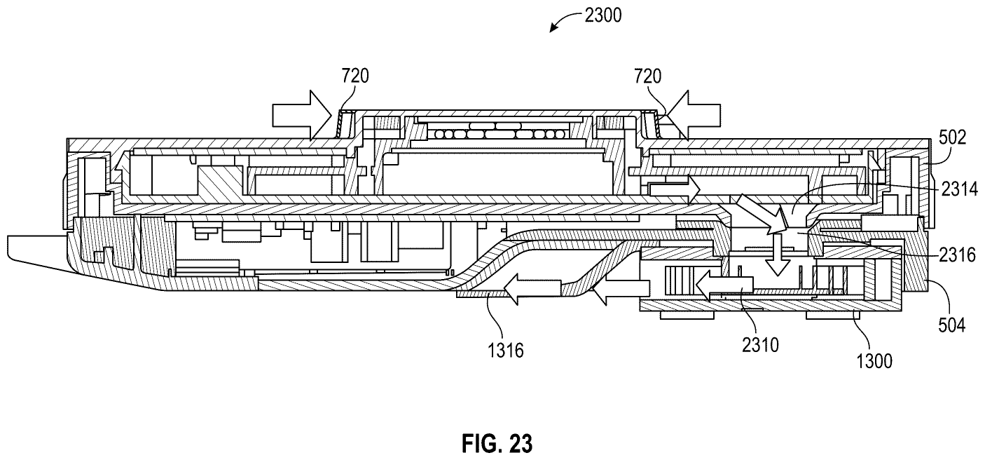

The fan 1300 can be a mechanical component that can be driven by a motor (such as an electric motor) to generate or direct an airflow based on a pressure differential, such as an axial or centrifugal fan or blower. The fan 1300 can be connected to or mounted within the base bottom cover 1302 of the base 504. The fan 1300 can be operable for motivating air (e.g., ambient air from the vehicle passenger compartment, etc.) to move into an inlet, through the wireless charging module, to an outlet (as shown in FIG. 23). The fan 1300 can work in conjunction with ventilation features in both the base 504 and a charging coil module, such as the charging coil module 502. When a wireless charger system 500 is assembled, an air channel can be formed and the fan 1300 can direct airflow around a charging coil for thermal management, such as cooling of the charging coil during charging operations.

The base bottom cover 1302 can be connected (directly or indirectly) to the base top cover 1310, such as through a snap-fit engagement. The connection between the base bottom cover 1302 and the base top cover 1310 can be made between the one or more base ridges 1312 and the base opening 1314 to form an interference fit. The one or more base ridges 1312 can be projections, protuberances, or connectors configured for insertion into the base openings 1314 to form a releasable connection. Optionally, the base bottom cover 1302 and the base top cover 1310 can be secured using fasteners, adhesive, or any combination thereof. When coupled, the base bottom cover 1302 and the base top cover 1310 can enclose other components of the base 504, such as the EMC shield 1304, the base PCBA 1306, or any combination thereof. In some examples, the base bottom cover 1302 can include the outlet 1316 as part of an airflow path, which can allow air drawn by the fan 1300 to exit a wireless charger system, as described in relation to FIG. 23.

The EMC shield 1304 can be an electromagnetic interference shield that can help limit magnetic fields from interfering with shielded components, such as those on the base PCBA 1306. The EMC shield 1304 can include a sheet metal (e.g., copper, brass, nickel, silver, steel, tin, etc.), metal screen, metal foam, or any other conductive or magnetic materials. The EMC shield 1304 can be connected to the base top cover 1310, such as through one or more hooks, tabs, snap-fit engagement, fasteners, adhesives, or any combination thereof. The EMC shield 1304 can be located at least partially over the base PCBA 1306 to provide shielding or protection for the base PCBA 1306 against electromagnetic interference.

The base top cover 1310 can connect to the base bottom cover 1302 to create a sealed or partially sealed assembly to help protect the internal components while maintaining airflow channels around the charging coils. The base top cover 1310 can include ventilation features which can assist with thermal management. The base top cover 1310 can include the base recesses 1318 adjacent corner portions of the top cover. The base recesses 1318 can be configured to receive (e.g., friction or interference fit, etc.) base magnets 1308 or a ferromagnetic metal member if a corresponding charging coil module includes magnets, such as coil magnet 706 of FIG. 7. Base magnets 1308 can be a removable electromagnetic component that can interface with the coil magnet 706 to magnetically couple the charging coil module 502 the base 504.

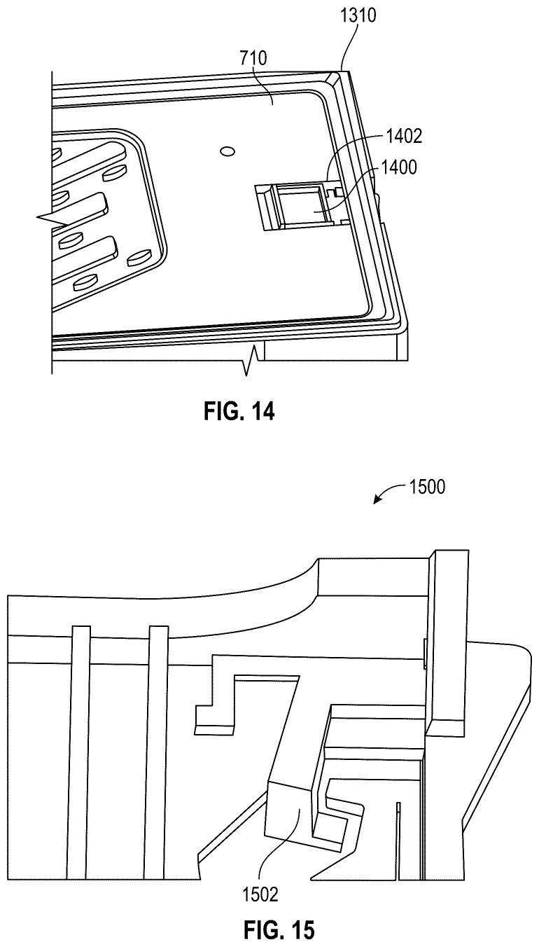

FIG. 14 is an isometric view of a slide switch 1400 in an example wireless charger system. The slide switch 1400 can be an actuating member that can be movable between configurations to releasably engage a base top cover 1310 with a module top cover 710.

The module top cover 710 can include a cutout 1402 configured to fit slide switch 1400. The slide switch 1400 can be used to removably couple a module top cover 710 with a base top cover 1310. The slide switch 1400 can be one example of a locking mechanism or actuating member to assist with attachment or detachment of a coil assembly 704.

The slide switch 1400 can have a first locked or secured configuration that can secure a charging coil module to a base. The slide switch 1400 can have a second unlocked or unsecured configuration that can allow for the release of the charging coil module (e.g., the charging coil module 502) from the base (e.g., the base 504). For example, the slide switch 1400 can integrate with a wireless charger, such as the wireless charger system 500 of FIG. 5, to provide releasable engagement between the charging coil module 502 and the base 504. The slide switch 1400 can allow users to attach or detach a charging coil module, such as charging coil module 502, from a base, such as base 504, without requiring specialized tools (e.g., with a user's finger, etc.).

FIG. 15 is an isometric view of a latching element 1500. The latching element 1500 can be an interlocking mechanism that can be movable between configurations to releasably engage components together. The latching element 1500 can be used to removably couple a top cover of a charging coil module, such as the module top cover 710 of FIG. 7, with a top cover of a base, such as the base top cover 1310 of FIG. 13. The latching element 1500 can be one example of a locking mechanism or actuating member to assist with attachment or detachment of a coil assembly 704 from a base (e.g., the base 504).

The latching element 1500 can have a first configuration that secures a charging coil module to a base. The latching element 1500 can have a second configuration that can allow for the release of a charging coil module from a base. The latching element 1500 can integrate with a wireless charger, such as the wireless charger system 500 of FIG. 5, to provide releasable engagement between the charging coil module 502 and the base 504. The latching element 1500 can include a movable arm 1502 that is user-actuatable to move the latching element 1500 between a locked configuration and an unlocked configuration to allow a user to attach or detach the charging coil module (e.g., the charging coil module 502) without requiring specialized tools. In some examples, the movable arm 1502 can be biased to the locked configuration.

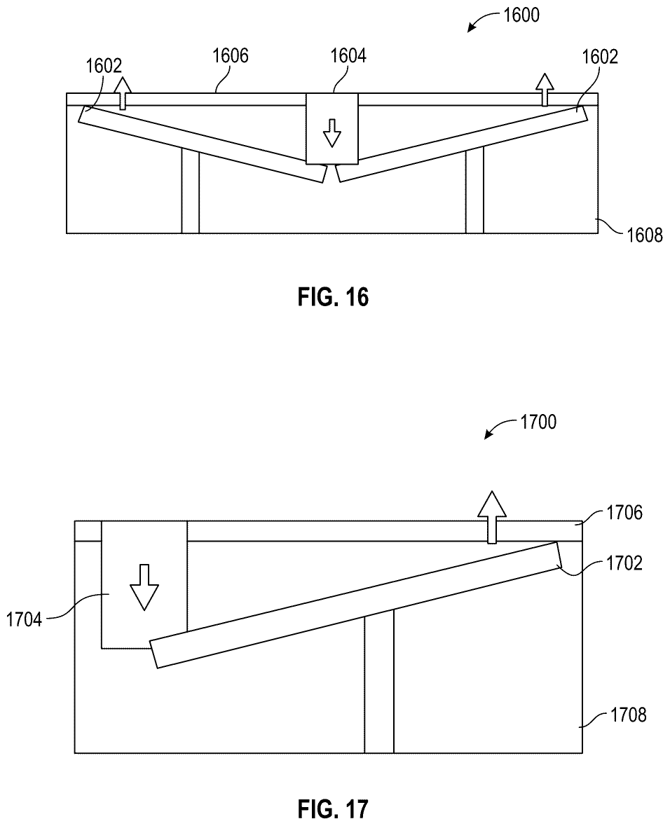

FIG. 16 is a side view diagram of a double lever system 1600 in an example charging coil module. The double lever system 1600 can include a switch 1602, which can be a double lever switch. The double lever system 1600 can also include a knob 1604, a charging coil module 1606, and a base 1608.

The switch 1602 can be a mechanical component with opposite pivot points. The switch 1602 can create or form a balanced lever, where pressing down (as shown by the down arrow) on one end of each switch can cause the corresponding opposite ends to raise (as shown by the up arrows). The switch 1602 can be activated by pressing down on the knob 1604, such as by a finger of a user, such as without use of a tool. The knob 1604 can be a protrusion, button, knob, etc. By pressing the knob 1604 down, adjacent sides of the switch 1602 can be pushed down while opposite sides can be raised up, which can move the charging coil module 1606 away from and off the base 1608, The double lever system 1600 can provide a balanced or controlled disengagement between a charging coil module 1606 and a base 1608. Providing a lifting force on two areas of the charging coil module 1606 can balance a force distribution, which can help prevent binding or uneven removal of the charging coil module 1606 from the base 1608.

FIG. 17 is a side view diagram of a single lever system 1700 in an example charging coil module. The single lever system 1700 can include a lever 1702, which can be a single lever switch. The single lever system 1700 can also include a knob 1704, a charging coil module 1706, and a base 1708.

The lever 1702 can be a mechanical component with a pivot point. The lever 1702 can create or form a balanced lever, where pressing down on one end of the switch can cause the opposite end of the switch to raise. The lever 1702 can be activated by can be pressing down on end by knob 1704 with a user's finger without using a tool. The knob 1704 can be a protrusion, button, knob, etc. If the knob 1704 is pressed down, a side of the lever 1702 can be pushed down while another side of the lever 1702 can be raised up, which can lift the charging coil module 1706 away from and off the base 1708. The single lever system 1700 can provide a mechanical design or construction with reduced complexity while still enabling the charging coil module 1706 to be removable from the base 1708. By having force distributed to only one area of the charging coil module 1706, less force can be used for disassembly purposes.

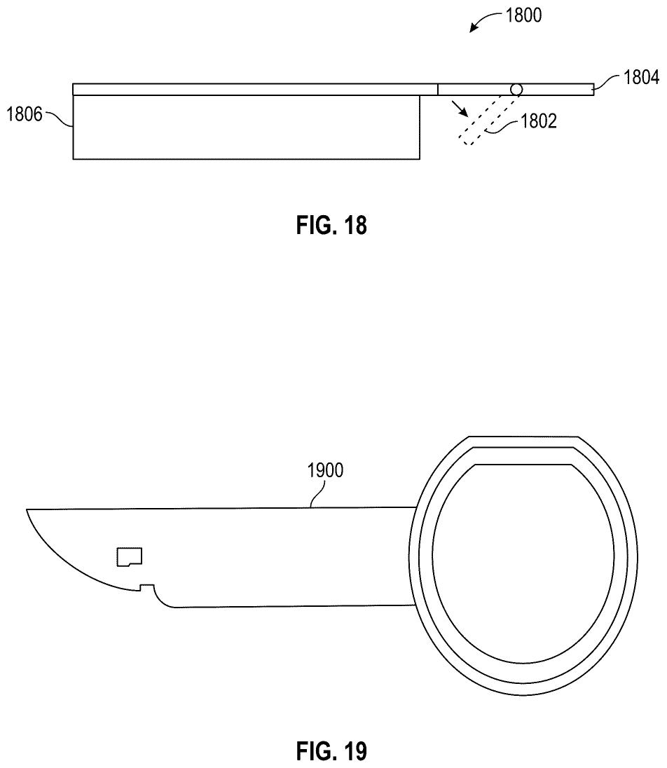

FIG. 18 is a side view diagram of a flap switch system 1800 in an example charging coil module. The flap switch system 1800 can include a switch 1802, which can be a flap-type switch. The flap switch system 1800 can also include a charging coil module 1804, and a base 1806.

The switch 1802 can be a hinged or flexible panel integrated into the charging coil module 1804. The switch 1802 can be pressed down such as by a finger of a user, for example without using a tool, which can allow the finger to be positioned under the edge of the charging coil module 1804 for lifting the charging coil module 1804 away from and off the base 1806 (e.g., in a direction of the arrow of FIG. 18). The flap switch system 1800 can provide a simple mechanism for removing the charging coil module 1804 from the base 1806. By providing direct access to the edge of the charging coil module 1804, a user can remove the charging coil module 1804 from the base 1806 without a specialized tool. The flap switch system 1800 can be included within a charging coil module 1804 without additional assemblies or mechanisms included in the base 1806.

FIG. 19 is a side view of a release tool 1900. The release tool can be a mechanical implement with a defined shape or structure that can be designed to interface with any of the lever or latching mechanisms described in FIGS. 14-18. The release tool 1900 can be used for unlocking, releasing, or unlatching an example charging coil module (e.g., the charging coil module 502) from an example base (e.g., the base 504). The release tool 1900 can be used instead of a household-related object (e.g., a paper clip, a screwdriver, etc.) or a standard shop tool (e.g., standard removal keys or standard screwdriver). The release tool 1900 or the household-related object can be used to lift the charging coil module by pushing down one side of a lever (e.g., as seen in FIGS. 16-17 etc.) while an opposite side of the lever lifts the charging coil module away from and off the base.

FIG. 20 is an isometric view of a tool 2000. The tool 2000 can be used for disassembly. The tool 2000 can be magnetic and can include at least one recess to house a magnet 2002. The magnet 2002 can be configured to be magnetically coupled with the coil magnet 706 of the charging coil module 502 of FIG. 7 according to an example. The magnet 2002 of the disassembly tool can be oriented so that the tool 2000 can only be used in one orientation relative to a charging coil module. When a magnet 2002 of the disassembly tool is magnetically coupled with a ferromagnetic metal member of the charging coil module, such as the coil magnet 706 of FIG. 7, the tool 2000 can be used to lift a respective away from and off a respective base.

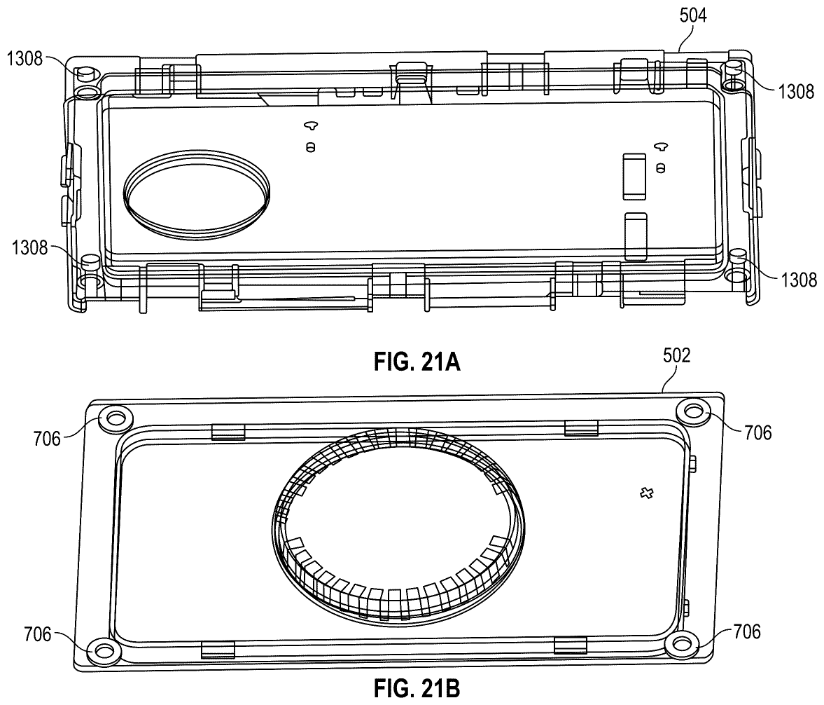

FIG. 21A is an isometric view of a base 504 in phantom showing base magnets 1308 included with the base 504 according to some examples. FIG. 21B is an isometric view of a charging coil module 502 in phantom showing coil magnet 706 included with the charging coil module 502 according to some examples. FIGS. 21A-21B are discussed together below.

The base magnets 1308 and the coil magnet 706 can be magnets or ferromagnetic metal members (e.g., plates, washers, etc.) for magnetically coupling the charging coil module 502 with the base 504. For example, the base 504 can include base magnets 1308 within recesses at, near, or adjacent corner portions of the top cover of the base 504. The charging coil module 502 can include a set of corresponding ferromagnetic metal members, such as coil magnet 706, within recesses adjacent corner portions of a top cover of the charging coil module 502. In other examples, the base 504 can include a set of ferromagnetic metal members, such as base magnets 1308, within recesses adjacent corner portions of the top cover of the base 504, and the charging coil module 502 can include a set of magnets, such as coil magnet 706, within recesses adjacent corner portions of the top cover of the charging coil module 502.

The base magnets 1308 and the coil magnet 706 can form a closed-loop magnetic flux between the base 504 and the charging coil module 502. The closed-loop magnetic flux can produce a holding force to secure the base 504 and the charging coil module 502 together. This holding force can have a magnitude such that the base 504 and the charging coil module 502 can stay magnetically coupled when an environmental force is applied (e.g., gravity, shock, etc.), but can still allow for intentional removal by an end user when desired. The base magnets 1308 and the coil magnet 706 can also provide a magnetic field such that the magnetic field produced by the base magnets 1308 and the coil magnet 706 does not violate any DC-magnetic field restrictions for desired applications as described below.

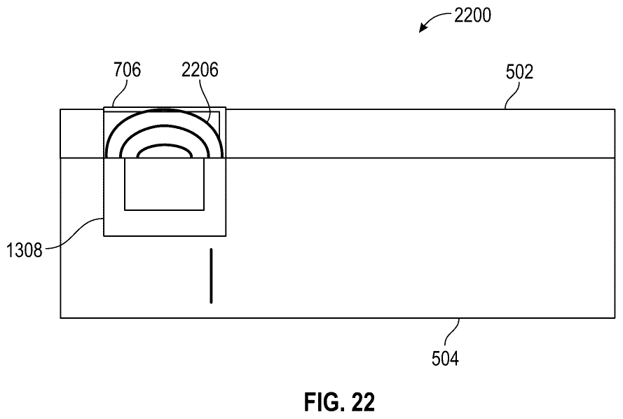

FIG. 22 is a side view diagram of a magnetic assembly 2200 of a wireless charging module according to some examples. The magnetic assembly 2200 can include base magnets 1308, a coil magnet 706, a magnetic field 2206, a charging coil module 502, and a base 504.

The base magnets 1308 can be u-shaped in cross-section such that the base magnets 1308 has an open top. The shape of base magnets 1308 create, in part, the magnetic field 2206, which can be a closed-loop magnetic flux that can form between the base magnets 1308 and the coil magnet 706 to create a holding force. The magnetic field 2206 can also hold a charging coil module 502 in place relative to the base 504. The base magnets 1308 and the coil magnet 706 can improve the strength of the magnetic field 2206 relative to other systems, such as axially adjacent magnets. In automotive applications, there can be a limit on a DC-magnetic field such that an allowed magnetic field strength is below a value required to hold a replacement coil module's cover in place. By increasing the magnetic field strength, the magnetic assembly 2200 can overcome a restriction on the DC-magnetic fields for desired applications (e.g., automotive, industrial, etc.). The magnetic assembly 2200 can work alongside other attachment mechanisms, such as the slide switch 1400 of FIG. 14 or the latching element 1500 of FIG. 15.

FIG. 23 illustrates an example active cooling system 2300 for a wireless charging module. The example active cooling system 2300 can include the base 504, the charging coil module 502, and an airflow path 2310. The charging coil module 502 can include inlet 720 and a coil duct 2314. The base 504 can include an outlet 1316, a fan 1300, and a base duct 2316.

The inlet 720 can be a vent, gap, opening, hole, or channel located at least partially in the charging coil module 502. The inlet 720 can allow air intake from the ambient environment. In some examples, there can be a plurality of the inlet 720. The inlet 720 may be located at various positions in the charging coil module 502 to improve airflow distribution through internal channels surrounding the charging coils.

The outlet 1316 can be a hole, slot, vent, or channel positioned within the base 504. The outlet 1316 can allow air to exit the wireless charging module. In some examples, there can be a plurality of the outlet 1316. The outlet 1316 can be incorporated at various positions in the base 504 to improve air evacuation from the airflow path 2310.

The airflow path 2310 (shown at least in part by the arrows of FIG. 23) can be at least partially defined from the inlet 720, through the wireless charging module, to the outlet 1316. The airflow path 2310 can be configured to direct air internally within the wireless charging module generally around or adjacent to an inductive charging coil of a charging coil module (e.g., a single MPP inductive charging coil or a single coil module or an MPP coil and a non-MPP coil of a multi-coil module).

The fan 1300 can be included in or connected to the base 504. The fan 1300 can be in fluid communication with or between the inlet 720 and the outlet 1316. The fan 1300 can be operable for motivating air (e.g., ambient air from a vehicle passenger compartment, etc.) into the inlet 720, through the wireless charging module, and to the outlet 1316. The fan 1300 can generate airflow based on a pressure differential created between the inlet 720 and outlet 1316. The pressure differential can drive air movement through the airflow path 2310 to provide cooling during wireless charging operations.

The coil duct 2314 can be defined through the charging coil module 502. The coil duct 2314 can be a channel included within the charging coil module 502 that forms a portion of a continuous passageway extending between inlet 720 and outlet 1316. The coil duct 2314 can include internal geometry that can align with corresponding features in the charging coil module 502 to establish a sealed interface.

The base duct 2316 can be defined through the base 504. The base duct 2316 can be a channel included with the base 504 that forms a portion of a continuous passageway extending between inlet 720 and outlet 1316. The base duct 2316 can include internal geometry that can align with corresponding features in the base 504 to establish a sealed interface. In some examples, the coil duct 2314 and the base duct 2316 can be sealed (i.e., water-tight, air-tight, etc.) to pass automotive standard gushing liquid tests. In some examples, there may be more than one fan included in the base 504.

The disclosure provided herein describes features in terms of preferred and some examples thereof. Numerous other embodiments, modifications and variations within the scope and spirit of the appended claims will occur to persons of ordinary skill in the art from a review of this disclosure.

### NOTES AND EXAMPLES

The following, non-limiting examples, detail certain aspects of the present subject matter to solve the challenges and provide the benefits discussed herein, among others.

Example 1 is a wireless charging module comprising: a base; a charging coil module releasably securable to the base, the charging coil module including one or more electrical connectors to electrically engage with the base when the charging coil module is secured to the base, the charging coil module interchangeable between a single coil module and a coil module, and the wireless charging module configured to wirelessly charge a mobile device when the charging coil module is secured to the base; and a switch movable between a first configuration and a second configuration, the switch configured to secure the charging coil module to the base in the first configuration, and the switch configured to release the charging coil module from the base in the second configuration.

In Example 2, the subject matter of Example 1 optionally includes wherein the charging coil module includes a switch movable between a first configuration and a second configuration, the switch configured to provide access to an edge of the charging coil module in the second configuration to allow a user to remove the charging coil module from the base.

In Example 3, the subject matter of Example 2 optionally includes wherein the switch is one of a flap switch, a slide switch, a double lever, or a single lever.

In Example 4, the subject matter of any one or more of Examples 1-3 optionally include wherein: the base includes a magnet; the charging coil module includes a ferromagnetic metal member; and the magnet of the base and the ferromagnetic metal member of the charging coil module cooperate to magnetically couple to secure the charging coil module to the base.

In Example 5, the subject matter of any one or more of Examples 1˜4 optionally include the charging coil module comprising a reed switch configured to interrupt an electrical circuit of the charging coil module.

In Example 6, the subject matter of any one or more of Examples 4-5 optionally include wherein the base includes a magnet configured such that the reed switch will interrupt the electrical circuit of the charging coil module when a distance between the reed switch and the magnet of the base exceeds a defined distance.

In Example 7, the subject matter of Example 6 optionally includes wherein: the charging coil module includes a first side and a second side, the second side opposite the first side, the second side including the reed switch; and a hook located on the first side of the charging coil module configured to limit the first side from being unlocked while the second side is removed from the base.

In Example 8, the subject matter of any one or more of Examples 1-7 optionally include wherein: the base includes a fan; the charging coil module includes a top cover, the top cover including a first vent in communication with the fan; the base includes a bottom cover, the bottom cover including a second vent in communication with the fan; and an airflow path is defined from the first vent of the top cover of the charging coil module through the wireless charging module to the second vent of the bottom cover of the base, whereby the airflow path allows an air flow internally within the wireless charging module generally around or adjacent one or more inductive charging coils of the charging coil module.

In Example 9, the subject matter of Example 8 optionally includes wherein the charging coil module and the base include or define an air duct, the air duct defining at least a portion of the airflow path, the air duct sealed to inhibit ingress of liquid therein.

In Example 10, the subject matter of any one or more of Examples 1-9 optionally include wherein: the charging coil module includes at least one inductive charging coil configured to be operable for transferring power wirelessly through a charging surface of the wireless charging module when the charging coil module is mounted to the base; and the wireless charging module includes a magnetic alignment component configured to magnetically couple with a complementary magnetic alignment component of a mobile device for aligning the mobile device on the charging surface of the wireless charging module.

In Example 11, the subject matter of Example 10 optionally includes wherein the at least one inductive charging coil of the charging coil module includes: a single MPP (Magnetic Power Profile) coil; a single coil; or a plurality of inductive charging coils including an MPP coil and a non-MPP coil.

In Example 12, the subject matter of any one or more of Examples 1-11 optionally include wherein the base is configured to receive a plurality of charging coil modules that are interchangeable such that each of the plurality of charging coil modules is selectively mountable to the base.

In Example 13, the subject matter of Example 12 optionally includes wherein the plurality of charging coil modules includes: a first charging coil module that includes a single MPP inductive charging coil; and a second charging coil module that includes a plurality of inductive charging coils including an MPP inductive charging coil and a non-MPP inductive charging coil.

In Example 14, the subject matter of Example 13 optionally includes wherein the first charging coil module and the second charging coil module are selectively interchangeable with each other such that the first charging coil module is replaceable with the second charging coil module whereby the wireless charging module is Qi2 compliant and operable for charging both MPP wireless charging receivers and non-MPP wireless charging receivers.

In Example 15, the subject matter of any one or more of Examples 1-14 optionally include wherein the charging coil module includes an MPP inductive charging coil configured according to or in compliance with a Qi2 wireless charging standard.

Example 16 is a wireless charging module comprising: a base; a charging coil module releasably securable to the base, the charging coil module including an electrical connector to electrically engage with the base when the charging coil module is secured to the base, the charging coil module selectively interchangeable between a single coil module and a multi-coil module to support different wireless charging standards; and a switch movable between a first configuration and a second configuration, the switch configured to secure the charging coil module to the base in the first configuration, and the switch configured to release the charging coil module from the base in the second configuration.

In Example 17, the subject matter of Example 16 optionally includes wherein: the charging coil module includes at least one inductive charging coil configured to be operable for transferring power wirelessly through a charging surface of the wireless charging module when the charging coil module is mounted to the base; and the wireless charging module includes a magnetic alignment component configured to magnetically couple with a complementary magnetic alignment component of a mobile device for aligning the mobile device on the charging surface of the wireless charging module.

In Example 18, the subject matter of Example 17 optionally includes wherein the at least one inductive charging coil of the charging coil module includes: a single MPP (Magnetic Power Profile) coil; or a plurality of inductive charging coils including an MPP coil and a non-MPP coil.

Example 19 is a wireless charging module comprising: a base; a charging coil module releasably securable to the base, the charging coil module including one or more electrical connectors to electrically engage with the base when the charging coil module is secured to the base, the charging coil module including at least one inductive charging coil configured to wirelessly transfer power through a charging surface of the wireless charging module when the charging coil module is secured to the base, the charging coil module interchangeable between: a first charging coil module including a first charging coil, the first charging coil a single MPP (Magnetic Power Profile) inductive charging coil; and a second charging coil module including the first charging coil and a second charging coil, the second charging coil a non-MPP inductive charging coil; and a switch movable between a first configuration and a second configuration, the switch configured to secure the charging coil module to the base in the first configuration, and the switch configured to release the charging coil module from the base in the second configuration.

In Example 20, the subject matter of Example 19 optionally includes wherein the wireless charging module is Qi2 compliant and operable for charging both MPP wireless charging receivers and non-MPP wireless charging receivers.

In Example 21, the subject matter of any one or more of Examples 19-20 optionally include wherein: the wireless charging module includes a reed switch configured to interrupt an electrical circuit of the charging coil module; and the base includes a magnet configured such that the reed switch will interrupt the electrical circuit of the charging coil module when a distance between the reed switch and the magnet of the base exceeds a defined distance.

In Example 22, the subject matter of any one or more of Examples 1-3 optionally include wherein the coil module includes a single coil module or a multi-coil module.

In Example 23, the apparatuses or method of any one or any combination of Examples 1-22 can optionally be configured such that all elements or options recited are available to use or select from.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) can be used in combination with each other. Other embodiments can be used, such as by one of ordinary skill in the art upon reviewing the above description. The Abstract is provided to comply with 37 C.F.R. § 1.72 (b), to allow the reader to quickly ascertain the nature of the technical disclosure. It is submitted with the understanding that it will not be used to interpret or limit the scope or meaning of the claims. Also, in the above Detailed Description, various features can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A wireless charging module comprising:
a base;
a charging coil module releasably securable to the base, the charging coil module including one or more electrical connectors to electrically engage with the base when the charging coil module is secured to the base, the charging coil module interchangeable between a single coil module and a coil module, and the wireless charging module configured to wirelessly charge a mobile device when the charging coil module is secured to the base; and
a switch movable between a first configuration and a second configuration, the switch configured to secure the charging coil module to the base in the first configuration, and the switch configured to release the charging coil module from the base in the second configuration.

2. The wireless charging module of claim 1, wherein the charging coil module includes a switch movable between a first configuration and a second configuration, the switch configured to provide access to an edge of the charging coil module in the second configuration to allow a user to remove the charging coil module from the base.

3. The wireless charging module of claim 2, wherein the switch is one of a flap switch, a slide switch, a double lever, or a single lever.

4. The wireless charging module of claim 1, wherein:
the base includes a magnet;
the charging coil module includes a ferromagnetic metal member; and
the magnet of the base and the ferromagnetic metal member of the charging coil module cooperate to magnetically couple to secure the charging coil module to the base.

5. The wireless charging module of claim 1, the charging coil module comprising a reed switch configured to interrupt an electrical circuit of the charging coil module.

6. The wireless charging module of claim 5, wherein the base includes a magnet configured such that the reed switch will interrupt the electrical circuit of the charging coil module when a distance between the reed switch and the magnet of the base exceeds a defined distance.

7. The wireless charging module of claim 6, wherein:
the charging coil module includes a first side and a second side, the second side opposite the first side, the second side including the reed switch; and
a hook located on the first side of the charging coil module configured to limit the first side from being unlocked while the second side is removed from the base.

8. The wireless charging module of claim 1, wherein:
the base includes a fan;
the charging coil module includes a top cover, the top cover including a first vent in communication with the fan;
the base includes a bottom cover, the bottom cover including a second vent in communication with the fan; and
an airflow path is defined from the first vent of the top cover of the charging coil module through the wireless charging module to the second vent of the bottom cover of the base, whereby the airflow path allows an air flow internally within the wireless charging module generally around or adjacent one or more inductive charging coils of the charging coil module.

9. The wireless charging module of claim 8, wherein the charging coil module and the base include or define an air duct, the air duct defining at least a portion of the airflow path, the air duct sealed to inhibit ingress of liquid therein.

10. The wireless charging module of claim 1, wherein:
the charging coil module includes at least one inductive charging coil configured to be operable for transferring power wirelessly through a charging surface of the wireless charging module when the charging coil module is mounted to the base; and
the wireless charging module includes a magnetic alignment component configured to magnetically couple with a complementary magnetic alignment component of a mobile device for aligning the mobile device on the charging surface of the wireless charging module.

11. The wireless charging module of claim 10, wherein the at least one inductive charging coil of the charging coil module includes:
a single MPP (Magnetic Power Profile) coil;
a single coil; or
a plurality of inductive charging coils including an MPP coil and a non-MPP coil.

12. The wireless charging module of claim 11, wherein the base is configured to receive a plurality of charging coil modules that are interchangeable such that each of the plurality of charging coil modules is selectively mountable to the base.

13. The wireless charging module of claim 12, wherein the plurality of charging coil modules includes:
a first charging coil module that includes a single MPP inductive charging coil; and
a second charging coil module that includes a plurality of inductive charging coils including an MPP inductive charging coil and a non-MPP inductive charging coil.

14. The wireless charging module of claim 13, wherein the first charging coil module and the second charging coil module are selectively interchangeable with each other such that the first charging coil module is replaceable with the second charging coil module whereby the wireless charging module is Qi2 compliant and operable for charging both MPP wireless charging receivers and non-MPP wireless charging receivers.

15. The wireless charging module of claim 1, wherein the charging coil module includes an MPP inductive charging coil configured according to or in compliance with a Qi2 wireless charging standard.

16. A wireless charging module comprising:
a base;
a charging coil module releasably securable to the base, the charging coil module including an electrical connector to electrically engage with the base when the charging coil module is secured to the base, the charging coil module selectively interchangeable between a single coil module and a multi-coil module to support different wireless charging standards; and
a switch movable between a first configuration and a second configuration, the switch configured to secure the charging coil module to the base in the first configuration, and the switch configured to release the charging coil module from the base in the second configuration.

17. The wireless charging module of claim 16, wherein:
the charging coil module includes at least one inductive charging coil configured to be operable for transferring power wirelessly through a charging surface of the wireless charging module when the charging coil module is mounted to the base; and
the wireless charging module includes a magnetic alignment component configured to magnetically couple with a complementary magnetic alignment component of a mobile device for aligning the mobile device on the charging surface of the wireless charging module.

18. The wireless charging module of claim 17, wherein the at least one inductive charging coil of the charging coil module includes:
a single MPP (Magnetic Power Profile) coil; or
a plurality of inductive charging coils including an MPP coil and a non-MPP coil.

19. A wireless charging module comprising:
a base;
a charging coil module releasably securable to the base, the charging coil module including one or more electrical connectors to electrically engage with the base when the charging coil module is secured to the base, the charging coil module including at least one inductive charging coil configured to wirelessly transfer power through a charging surface of the wireless charging module when the charging coil module is secured to the base, the charging coil module interchangeable between:
a first charging coil module including a first charging coil, the first charging coil a single MPP (Magnetic Power Profile) inductive charging coil; and
a second charging coil module including the first charging coil and a second charging coil, the second charging coil a non-MPP inductive charging coil; and
a switch movable between a first configuration and a second configuration, the switch configured to secure the charging coil module to the base in the first configuration, and the switch configured to release the charging coil module from the base in the second configuration.

20. The wireless charging module of claim 19, wherein the wireless charging module is Qi2 compliant and operable for charging both MPP wireless charging receivers and non-MPP wireless charging receivers.

21. The wireless charging module of claim 19, wherein:
the wireless charging module includes a reed switch configured to interrupt an electrical circuit of the charging coil module; and
the base includes a magnet configured such that the reed switch will interrupt the electrical circuit of the charging coil module when a distance between the reed switch and the magnet of the base exceeds a defined distance.
